(19) United States
(12) Patent Application Publication
(10) Pub. No.: US 2014/0078936 A1
(43) Pub. Date: Mar. 20, 2014

(54) APPARATUS FOR CONFIGURING OVERLAY NETWORK AND METHOD THEREOF

(71) Applicant: Electronics and Telecommunications Research Institute, Daejeon (KR)

(72) Inventors: Byeong Sik KIM, Daejeon (KR); Tae Yeon KIM, Daejeon (KR); Byong Kwon MOON, Daejeon (KR); Seung Hyun YOON, Daejeon (KR); Byung Joon LEE, Daejeon (KR); Hong Seok JEON, Daejeon (KR); Hyung Seok CHUNG, Daejeon (KR); Ho Young SONG, Daejeon (KR)

(21) Appl. No.: 13/924,447

(22) Filed: Jun. 21, 2013

(30) Foreign Application Priority Data
Sep. 17, 2012 (KR) 10-2012-0102760

(51) Int. Cl. H04L 12/24

(52) U.S. Cl. CPC H04L 41/0823
USPC 370/255

(57) ABSTRACT

Disclosed are an apparatus for configuring an overlay network and a method thereof. An apparatus for configuring an overlay network may include a network configuring device collecting topology information and bandwidth information of a physical network and configuring one logical network including a plurality of predetermined nodes by using the collected topology information and bandwidth information of the physical network; and a storage device storing the topology information and bandwidth information of the physical network.

### CROSS-REFERENCE TO RELATED APPLICATIONS

This application claims priority to and the benefit of Korean Patent Application No. 10-2012-0102760 filed in the Korean Intellectual Property Office on Sep. 17, 2012, the entire contents of which are incorporated herein by reference.

### TECHNICAL FIELD

The present invention relates to a method for configuring an overlay network, and particularly, to an apparatus for configuring an overlay network and a method thereof that collect topology information and bandwidth information of a physical network in real time and configure a logical network on the physical network by using the collected topology information and bandwidth information.

### BACKGROUND

An overlay network is a physical or logical network that is configured on a network and nodes of the overlay network may be considered to be connected to each other by virtual links and logical links. In this case, a link of the overlay network may be considered as a channel constituted by a plurality of links in a lower network. In other words, the overlay network represents a network that may improve performance, increase efficiency, and provide various functions by further reconfiguring a logical topology on an existing topology that exists physically or logically by another need.

Present methods include most methods in which a network operator manually uses a generic routing encapsulation tunnel (GRE) technique, an IP security (IPsec) technique, or a multi-protocol label switching (MPLS) technique and do not include a method capable of configuring an overlay network in which a quality of service (QoS) is automatically secured.

### SUMMARY

The present invention has been made in an effort to provide an apparatus for configuring an overlay network and a method thereof that collect topology information and bandwidth information of a physical network in real time and configure a logical network on the physical network by using the collected topology information and bandwidth information.

An exemplary embodiment of the present invention provides an apparatus for configuring an overlay network, including: a network configuring device collecting topology information and bandwidth information of a physical network and configuring one logical network including a plurality of predetermined nodes by using the collected topology information and bandwidth information of the physical network; and a storage device storing the topology information and bandwidth information of the physical network.

The network configuring device may include an information collecting unit collecting the topology information and bandwidth information of the physical network; a path calculating unit calculating the shortest path among the plurality of predetermined nodes by using the collected topology information and bandwidth information of the physical network; and a tunnel setting unit transferring a command to instruct setting of a tunnel to the plurality of nodes which belongs to the calculated shortest path.

The information collecting unit may collect link information among the respective nodes and available bandwidth information of respective links from all of the nodes which belong to the physical network by using a simple network management protocol (SNMP).

The information collecting unit may collect the topology information and the available bandwidth information of the physical network from any one node of all of the nodes which belong to the physical network by using a link status advertisement message.

The path calculating unit may calculate the shortest path among the plurality of predetermined nodes by using a shortest path first (SPF) algorithm.

The tunnel setting unit may transfer the command to instruct setting of the tunnel to all of the nodes which belong to the calculated shortest path.

The tunnel setting unit may transfer the command to instruct setting of the tunnel to the predetermined nodes of all of the nodes which belong to the calculated shortest path.

The apparatus may further include a management device receiving a command for configuring the logical network from the network operator and transmitting the received command to the network configuring device.

Another exemplary embodiment of the present invention provides a method for configuring an overlay network, including: collecting topology information and bandwidth information of a physical network; and configuring one logical network including a plurality of predetermined nodes by using the topology information and the bandwidth information of the physical network.

The configuring of the network may include calculating the shortest path among the plurality of predetermined nodes by using the collected topology information and bandwidth information of the physical network; and transferring a command to instruct setting of a tunnel to the plurality of nodes which belongs to the calculated shortest path.

In the collecting of the information, link information among respective nodes and available bandwidth information of respective links may be collected from all of the nodes which belong to the physical network by using a simple network management protocol (SNMP).

In the collecting of the information, the topology information and the available bandwidth information of the physical network may be collected from any one node of all of the nodes which belong to the physical network by using a link status advertisement message.

In the calculating of the path, the shortest path among the plurality of predetermined nodes may be calculated by using a shortest path first (SPF) algorithm.

In the transferring of the command, a command to instruct setting of a tunnel may be transferred to all of the nodes which belong to the calculated shortest path.

In the transferring of the command, the command to instruct setting of the tunnel may be transferred to the predetermined nodes of all of the nodes which belong to the calculated shortest path.

The method may further include receiving a command for configuring the logical network from the network operator and transmitting the received command to the network configuring device.

According to the exemplary embodiments of the present invention, topology information and bandwidth information of a physical network are collected in real time and a logical network on the physical network is configured by using the collected topology information and bandwidth information to efficiently configure an overlay network.

Topology information and bandwidth information of a physical network are collected in real time and a logical network on the physical network is configured by using the collected topology information and bandwidth information to automatically configure an overlay network capable of providing various services.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating an apparatus for configuring an overlay network according to an exemplary embodiment of the present invention.

FIG. 2 is a diagram illustrating a detailed configuration of the network configuring apparatus 120 illustrated in FIG. 1.

FIG. 3 is a first diagram for describing a principle of collecting information according to an exemplary embodiment of the present invention.

FIG. 4 is a second diagram for describing a principle of collecting information according to an exemplary embodiment of the present invention.

FIG. 5 is a diagram for describing a principle for setting a tunnel according to an exemplary embodiment of the present invention.

FIG. 6 is a diagram for describing an overlay network generated according to an exemplary embodiment of the present invention.

FIG. 7 is a diagram illustrating a method for configuring an overlay network according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

In particular, the present invention discusses a new overlay network configuring scheme that collects topology information and bandwidth information of a physical network in real time and configures a logical network on the physical network by using the collected topology information and bandwidth information.

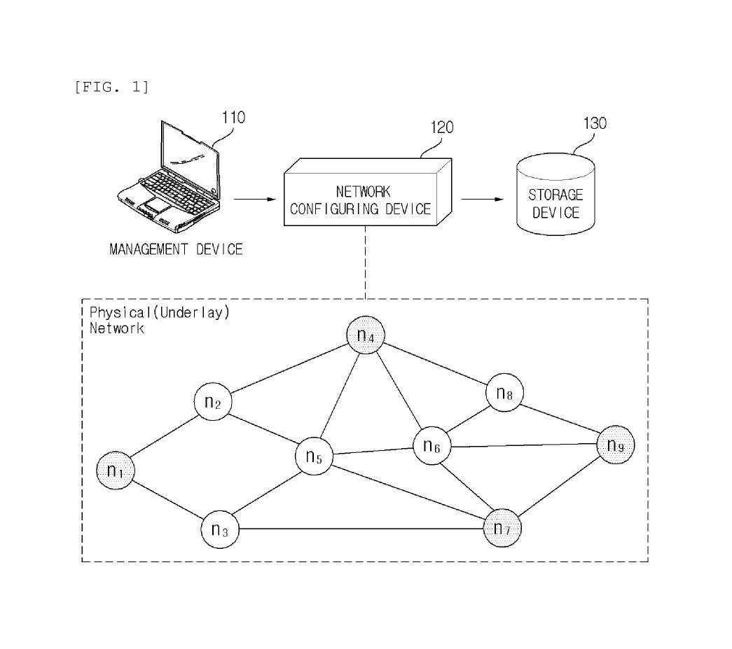

FIG. 1 is a diagram illustrating an apparatus for configuring an overlay network according to an exemplary embodiment of the present invention.

As illustrated in FIG. 1, the apparatus for configuring an overlay network according to the exemplary embodiment of the present invention may be configured to include a management device 110, a network configuring device 120, and a storage device 130.

The management device 110 receives addresses of nodes to be included in the overlay network from a network operator in order for the network operator to configure the desired overlay network to transmit the received addresses of the nodes to the network configuring device 120.

In this case, the management device 110 needs to transfer a desired bandwidth value together in order for the network operator to configure an overlay network to satisfy or secure the network operator's desired bandwidth.

For example, the management device 110 may transfer the following type of command to the network configuring device 120.

Overlay_Network_Request (n1, n4, n7, n9, 1M);

The command means instructing configuring an overlay network that includes a plurality of nodes n1, n4, n7, and n9, which the network operator desires, and satisfies a bandwidth of 1 Mbps.

The network configuring device 120 may collect topology information and bandwidth information of a physical network in real time. In this case, the network configuring device 120 collects link information among the respective nodes and available bandwidth information of the respective links from all nodes which belong to the physical network or collects topology information and available bandwidth information of the physical network from any one node of all of the nodes which belong to the physical network.

The network configuring device 120 may calculate a shortest path between the nodes by using the collected topology information and bandwidth information and configure a logical network including a plurality of predetermined nodes based on the calculated shortest path between the nodes. The storage device 130 may store the topology information and bandwidth information of the physical network. In this case, the storage device 130 is implemented as one device which is physically combined to store both the topology information and the bandwidth information or implemented as a plurality of devices which is physically separated to separately store the topology information and the bandwidth information.

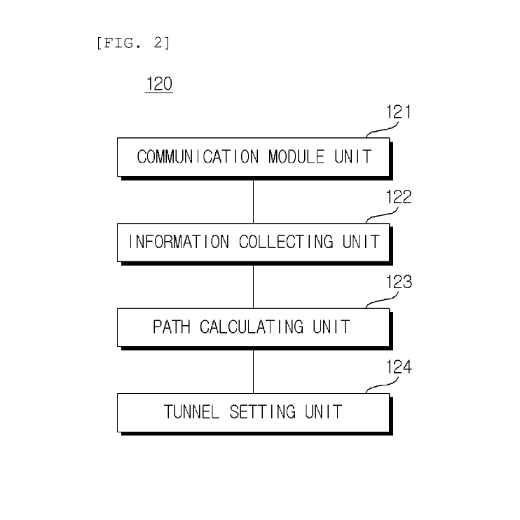

FIG. 2 is a diagram illustrating a detailed configuration of the network configuring apparatus 120 illustrated in FIG. 1.

As illustrated in FIG. 2, the network configuring device 120 according to the exemplary embodiment of the present invention may include a communication module unit 121, an information collecting unit 122, a path calculating unit 123, a tunnel setting unit 124, and the like.

The communication module unit 121 interworks with the management device 110 to receive the addresses of the nodes to be included in the overlay network received from the network operator or interworks with the storage device 130 to transfer the collected topology information and bandwidth information to the storage device 130.

The information collecting unit 122 may collect the topology information and the bandwidth information of the physical network in real time.

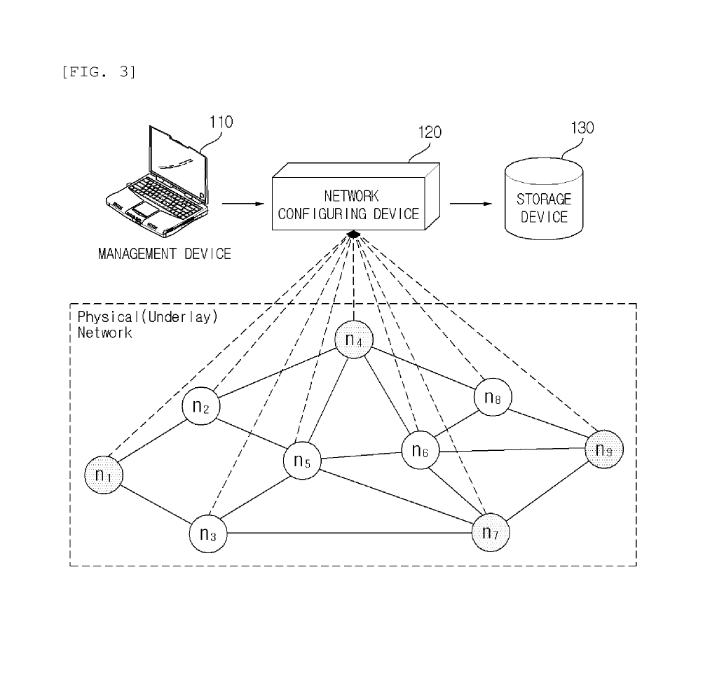

FIG. 3 is a first diagram for describing a principle of collecting information according to an exemplary embodiment of the present invention.

As illustrated in FIG. 3, the information collecting unit 122 according to the exemplary embodiment of the present invention may collect the link information among the respective nodes and the available bandwidth information of the respective links from all of the nodes which are included in the physical network by using a simple network management protocol (SNMP).

That is, the information collecting unit 122 according to the exemplary embodiment of the present invention collects various pieces of information from all of the nodes which belong to the network by using the SNMP on the network based on the a transmission control protocol/Internet protocol (TCP/IP).

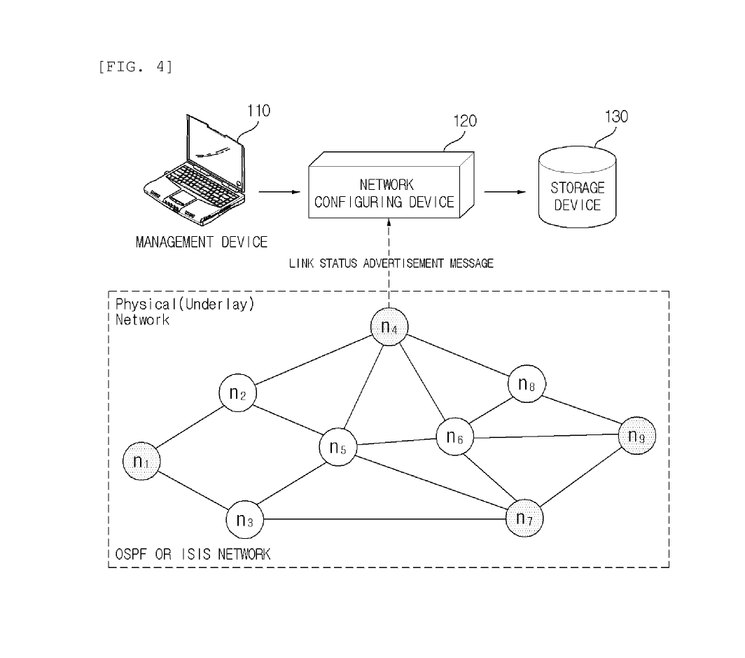

FIG. 4 is a second diagram for describing a principle of collecting information according to an exemplary embodiment of the present invention.

As illustrated in FIG. 4, the information collecting unit 122 according to the exemplary embodiment of the present invention may collect the topology information and the available bandwidth information of the physical network from any one node of all of the nodes which belong to the physical network by using a link status advertisement message.

That is, the information collecting unit 122 according to the exemplary embodiment of the present invention is connected to any one node which belongs to the network based on a link status routing protocol such as open shortest path first-traffic engineering (OSPE-TE) or intermediate system to intermediate system-traffic engineering (ISIS-TE) and detects the link status advertisement message from the connected node to collect the information included in the detected link status advertisement message, for example, the link information of the respective nodes and the available bandwidth information of the respective links.

The path calculating unit 123 may calculate the shortest path among the plurality of nodes by using a shortest path first (SPF) algorithm based on the collected topology information and bandwidth information. Herein, the SPF algorithm refers to an algorithm for selecting an optimal path based on a link status.

In this case, the path calculating unit 123 calculates the shortest path among the plurality of nodes n1, n4, n7, and n9 which satisfies the bandwidth which the network operator desires. For example, the shortest path of the nodes n1 and n4 becomes n1, n2, and n4, the shortest path of the nodes n1 and n7 is n1, n3, and n7, the shortest path of the nodes n4 and n7 becomes n4, n5, and n7, the shortest path of the nodes n4 and n9 becomes n4, n8, and n9, and the shortest path of the nodes n7 and n9 becomes n7 and n9.

The tunnel setting unit 124 may transfer a command to instruct setting of a tunnel to the plurality of nodes based on the calculated shortest path between the nodes.

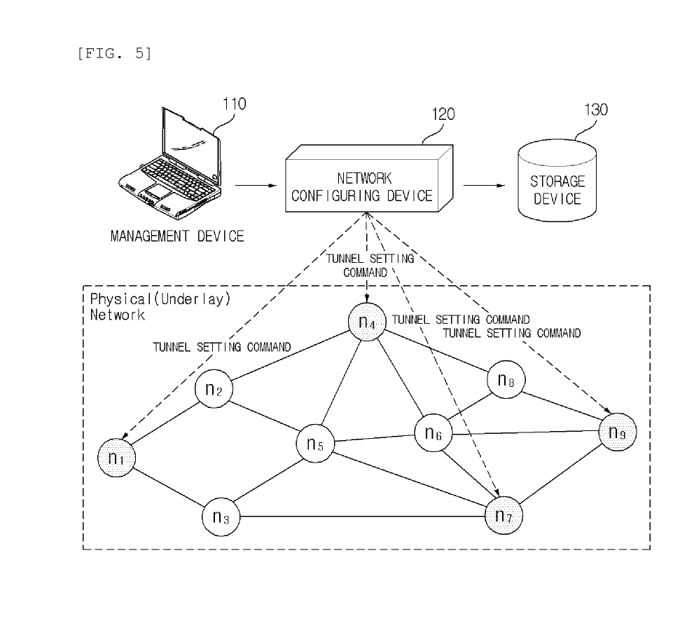

FIG. 5 is a diagram for describing a principle for setting a tunnel according to an exemplary embodiment of the present invention.

As illustrated in FIG. 5, the tunnel setting unit 124 according to the exemplary embodiment of the present invention may transfer the command to instruct setting of the tunnel to the plurality of nodes based on the calculated shortest path between the nodes.

As an example, in the case of the network based on the TCP/IP, the tunnel setting unit 124 may transfer the command to instruct setting of an internet protocol (IP) tunnel to the plurality of predetermined nodes n1, n4, n7, and n9 included in the calculated shortest path among the nodes and the command has the following type. #ip tunnel add (tunnel name) mode gre remote (IP address of destination node) local (IP address of source node) ttl 255

In this case, a command to instruct setting the node n4 and the IP tunnel to the node n1 may be expressed as follows.

#ip tunnel add (tunnel name) mode gre remote (IP address of n4) local (IP address of n1) ttl 255

As another example, in the case of a network which supports multi-protocol label switching (MPLS), the tunnel setting unit 124 may transfer a command to instruct setting of a label switched path (LSP) tunnel to all of the plurality of nodes n1, n2, n3, n4, n5, n7, n8, and n9 which are included in the calculated shortest path between the nodes and the command has the following type.

#LSP_Setup(source node, intermediate node, destination node);

In this case, a command to instruct setting the node n4 and the LSP tunnel to the node n1 may be expressed as follows.

#LSP_Setup (n1, n2, n4);

When the command is transferred, a tunnel from the node n1, to the node n4 may be set. The tunnel is considered as one link from the node n1 to the node n4 in the case of the logical network.

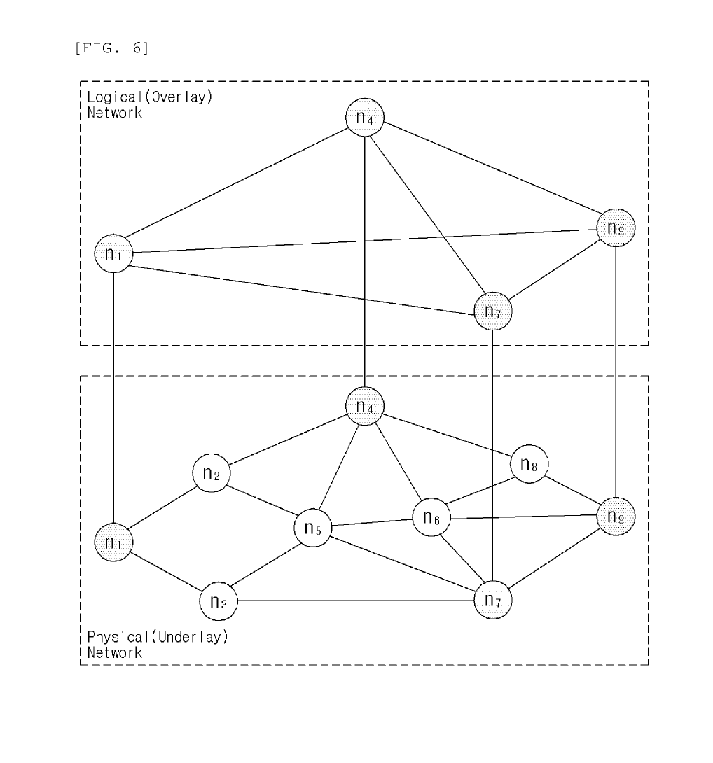

FIG. 6 is a diagram for describing an overlay network generated according to an exemplary embodiment of the present invention.

As illustrated in FIG. 6, the logical network constituted by the nodes n1, n4, n7, and n9 is configured after setting the tunnel among the plurality of nodes n1, n4, n7, and n9 on the physical network and the configured logical network is called an overlay network.

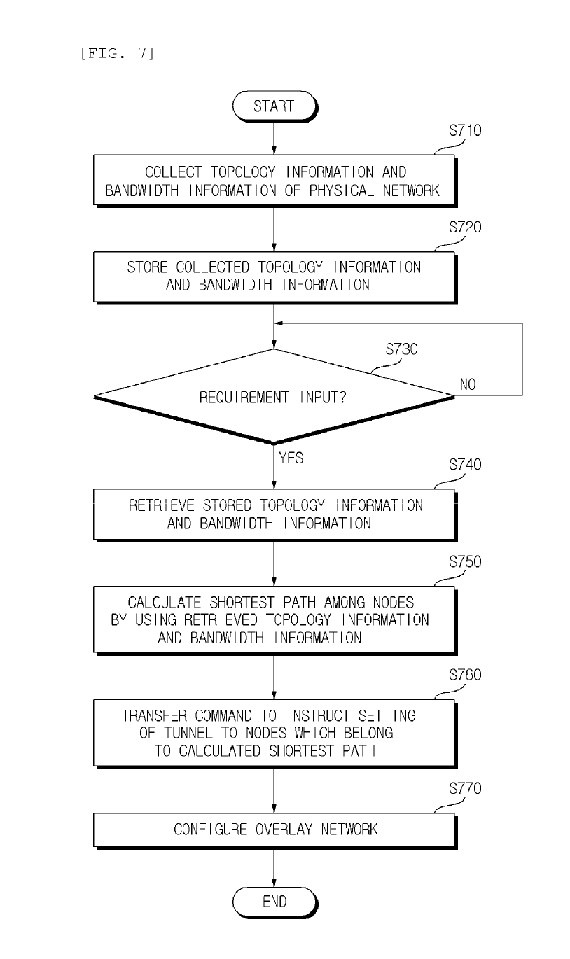

FIG. 7 is a diagram illustrating a method for configuring an overlay network according to an exemplary embodiment of the present invention.

As illustrated in FIG. 7, a network configuring device according to the exemplary embodiment of the present invention may collect topology information and bandwidth information of a physical network (S710). That is, the network configuring device collects link information among the respective nodes and available bandwidth information of the respective links from all nodes which belong to the physical network or collects topology information and available bandwidth information of the physical network from any one node of all of the nodes which belong to the physical network.

Next, the network configuring device may store the collected topology information and bandwidth information of the physical network (S720) and periodically or frequently update the stored topology information and bandwidth information as necessary.

Next, a database for the topology information and the bandwidth information of the physical network is constituted and thereafter, the network configuring device may receive a requirement from a network operator. Herein, the requirement may include addresses of a plurality of nodes, a bandwidth, and the like (S730).

Next, the network configuring device may retrieve information corresponding to the requirement received from the network operator among the stored topology information and bandwidth information of the physical network (S740).

Next, the network configuring device may calculate a shortest path between a plurality of predetermined nodes by using the retrieved topology information and bandwidth information of the physical network (S750).

In this case, the network configuring device calculates the shortest path among the plurality of nodes by using an SPF algorithm based on the collected topology information and bandwidth information of the physical network.

Next, the network configuring device may transfer a command to instruct setting of a tunnel to the plurality of nodes which belong to the calculated shortest path (S760). That is, the tunnel setting unit 124 transfers a command to instruct setting of an IP tunnel to the plurality of nodes based on the calculated shortest path among the nodes in the case of a network based on a TCP/IP or transfers a command to instruct setting of an LSP tunnel to the plurality of nodes based on the calculated shortest path among the nodes in the case of a network that supports MPLS.

When the tunnel is set as such, as a logical network including the plurality of nodes is configured, an overlay network which the network operator desires may be configured (S770).

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for configuring an overlay network, comprising:
a network configuring device collecting topology information and bandwidth information of a physical network and configuring one logical network including a plurality of predetermined nodes by using the collected topology information and bandwidth information of the physical network; and
a storage device storing the topology information and bandwidth information of the physical network.

2. The apparatus of claim 1, wherein the network configuring device includes:
an information collecting unit collecting the topology information and bandwidth information of the physical network;
a path calculating unit calculating the shortest path among the plurality of predetermined nodes by using the collected topology information and bandwidth information of the physical network; and
a tunnel setting unit transferring a command to instruct setting of a tunnel to the plurality of nodes which belongs to the calculated shortest path.

3. The apparatus of claim 2, wherein the information collecting unit collects link information among the respective nodes and available bandwidth information of respective links from all of the nodes which belong to the physical network by using a simple network management protocol (SNMP).

4. The apparatus of claim 2, wherein the information collecting unit collects the topology information and the available bandwidth information of the physical network from any one node of all of the nodes which belong to the physical network by using a link status advertisement message.

5. The apparatus of claim 2, wherein the path calculating unit calculates the shortest path among the plurality of predetermined nodes by using a shortest path first (SPF) algorithm.

6. The apparatus of claim 2, wherein the tunnel setting unit transfers the command to instruct setting of the tunnel to all of the nodes which belong to the calculated shortest path.

7. The apparatus of claim 2, wherein the tunnel setting unit transfers the command to instruct setting of the tunnel to the predetermined nodes of all of the nodes which belong to the calculated shortest path.

8. The apparatus of claim 1, further comprising:
a management device receiving a command for configuring the logical network from the network operator and transmitting the received command to the network configuring device.

9. A method for configuring an overlay network, comprising:
collecting topology information and bandwidth information of a physical network; and
configuring one logical network including a plurality of predetermined nodes by using the topology information and the bandwidth information of the physical network.

10. The method of claim 9, wherein the configuring of the network includes:
calculating the shortest path among the plurality of predetermined nodes by using the collected topology information and bandwidth information of the physical network; and
transferring a command to instruct setting of a tunnel to the plurality of nodes which belongs to the calculated shortest path.

11. The method of claim 10, wherein in the collecting of the information, link information among respective nodes and available bandwidth information of respective links are collected from all of the nodes which belong to the physical network by using a simple network management protocol (SNMP).

12. The method of claim 10, wherein in the collecting of the information, the topology information and the available bandwidth information of the physical network are collected from any one node of all of the nodes which belong to the physical network by using a link status advertisement message.

13. The method of claim 10, wherein in the calculating of the path, the shortest path among the plurality of predetermined nodes is calculated by using a shortest path first (SPF) algorithm.

14. The method of claim 10, wherein in the transferring of the command, a command to instruct setting of a tunnel is transferred to the plurality of nodes which belongs to the calculated shortest path.

15. The method of claim 10, wherein in the transferring of the command, the command to instruct setting of the tunnel is transferred to the predetermined nodes of all of the nodes which belong to the calculated shortest path.

16. The method of claim 9, further comprising:
receiving a command for configuring the logical network from the network operator and transmitting the received command to the network configuring device.
